(19) United States
(12) Patent Application Publication
(10) Pub. No.: US 2007/0102335 A1
(43) Pub. Date: May 10, 2007

(54) Apparatus and method for denitrification of treated water from aerobic wastewater treatment systems

(76) Inventor: Jerry L. McKinney, Silsbee, TX (US)

Correspondence Address: C. JAMES BUSHMAN, 5718 WESTHEIMER, SUITE 1800, HOUSTON, TX, 77057, US

(21) Appl. No.: 11/590,139

(22) Filed: Oct. 31, 2006

Related U.S. Application Data
(60) Provisional application No. 60/732,571, filed on Nov. 2, 2005.

(51) Int. Cl. C02F 3/12; C02F 3/02

(52) U.S. Cl. 210/194; 210/114

(57) ABSTRACT

An apparatus and method for denitrifying wastewater wherein treated wastewater having a high DO and being highly nitrified is exchanged with wastewater which is anoxic to provide an environment for the denitrification of the highly nitrified wastewater, the method and apparatus including a system for controlling DO in the anoxic wastewater.

### CROSS REFERENCE TO RELATED APPLICATION

This application claims the priority of U.S. Provisional Application No. 60/732,571 filed on Nov. 2, 2005, the disclosure of which is incorporated herein by reference for all purposes.

### BACKGROUND OF THE INVENTION

1. Field of the Invention

The present invention relates to aerobic wastewater treatment systems, particularly residential wastewater treatment systems and, more particularly, to the denitrification of treated water from such aerobic wastewater treatment systems.

2. Description of the Prior Art

Typical residential aerobic wastewater treatment systems comprise a pre-treatment vessel or tank, an aerobic digestion vessel or tank and a pump vessel or tank. In operation, the raw wastewater, which can be a mixture of so-called black water and grey water from a residence flows to the pre-treatment tank where the bulk of the solids settle out. The largely solids free water from the pre-treatment tank flows into the aerobic digestion tank where under the influence of an oxygen containing gas, the bacteria aerobically digests the organic solids carried over from the pre-treatment tank. Most aerobic digestion tanks (aeration tank) are comprised of a so-called aeration chamber and a clarifier chamber, digestion of the suspended and dissolved organic solids being conducted in the aeration chamber, substantially clarified water being removed from the clarifier chamber which then flows by gravity into the pump tank, a holding tank or in some cases for direct disposal.

Wastewater generally contains large amounts of nitrogen in the form of nitrates (NO₃⁻), nitrite (NO₂⁻), ammonia (NH₄⁺) and nitrogen gas (N2). All these forms of nitrogen are biochemically interconvertible, the former three being nitrogen nutrients. Nitrogen nutrients from wastewater can lead to the nutrient enrichment of water bodies causing excessive growth of aquatic plants (algae). The dissolved oxygen in the water body becomes depleted when the aquatic plants die, fall to the bottom and then are decomposed by aerobic bacteria. The oxygen depletion can reduce the population of indigenous fish and other oxygen-consuming organisms. Nitrogen nutrients from wastewater have also been linked to ocean “red tides” that poison fish and cause illness in humans. Lastly, nitrogen nutrients in drinking water may contribute to miscarriages and is known to be the cause of a serious illness in infants called “Blue Baby Syndrome”. Of the nitrogen nutrients, nitrates cause the greatest problem.

Accordingly, it is important for aerobic wastewater treatment system to produce treated water which, to the extent possible, is nitrogen nutrient poor and, in particular, contains the minimum amount possible of nitrates.

It is known that there are denitrifying bacteria that can convert dissolved nitrate into harmless nitrogen gas. For denitrifying bacteria to work, several things are required: (1) a source of energy, e.g., organic material, (2) an anoxic environment (one with little to no oxygen gas present), (3) nitrate and (4) efficient mixing and residue time.

To deal with the problem of producing nitrate-free treated water from aerobic wastewater treatment plants, it has been proposed to recycle a portion of the effluent from the pump tank to the pre-treatment tank. Although in the pretreatment tank there is sufficient energy available in the form of organic matter, nitrate is plentiful and the system is generally anoxic, the mixing/residence time between the denitrifying bacteria and the nitrates are in question. In any event, it has generally been accepted that this method results in reduced nitrate content in the treated wastewater.

A typical residential aerobic wastewater treatment plant has a capacity of 500 gallons a day. In the prior art system, recycle of too large of a volume of the treated wastewater from the pump tank to the pretreatment tank can overload the clarifier tank. However, conventionally prior art systems operate in this manner. In this regard, recycle occurs whenever the pump in the pump tank is discharging the treated wastewater in the pump tank.

### SUMMARY OF THE INVENTION

According to one aspect of the present invention, a recycle stream of the treated wastewater is trickled back to the pretreatment tank during times when the wastewater treatment plant is at minimum usage, e.g., at night, to avoid overloading the aeration tank's clarifier or a timer/pump combination is used to intermittently dose back some of the treated wastewater to the pre-treatment tank over each twenty-four hour period. Thus, under the second scenario, at desired intervals and for a fixed period of time the timer would activate a pump, which could be the pump used to normally pump water from the pump tank, to return, via a suitable solenoid/valving system some of the treated wastewater to the pre-treatment tank. This dosing prevents overload of the system, i.e., the clarifier, just as the continuous trickle or small slip-stream recycle during off hours does not overload the system.

The advantage of the above aspect of the present invention, as compared with the prior art method, is that for denitrification to effectively work such that the treated wastewater stream which is ultimately discharged is low in nitrates, a relatively large volume of the treated water in the pump tank must be recycled to an anoxic environment, i.e., the pretreatment tank. However, this presents a catch 22 situation. If, as is done in the prior art system, recycle occurs every time the pump in the pump tank comes on, the surge of recycle will interfere with the operation of the clarifier because the volume being handled by the system is too great. By using the two above discussed aspects of the present invention, one achieves the dual benefit of being able to recycle a large portion of the treated wastewater but do it in such a way that there is no overload of the clarifier.

Another aspect of the present invention involves the use of a separate tank which can be called a recycle tank and which is connected to the aeration chamber of the aerobic digestion tank. In one scenario the recycle tank is positioned relative to the aeration tank such that flow from the aeration chamber into the recycle tank occurs by gravity. In this case, a pump can be disposed in the recycle tank, the pump being connected to a timer and to a recycle line which recycles water from the recycle tank back to the aeration vessel. This accomplishes the purpose of providing adequate mixing, long residence times in the recycle tank, and since there is sufficient organic matter from the water from the aeration chamber, the necessary energy. Additionally, the water in the recycle tank is in a generally anoxic environment, i.e., >0 up to about 1 ppm oxygen. Accordingly, all of the conditions necessary for conversion of nitrates to nitrogen gas are present in the recycle tank.

In another aspect of the present invention, the relative positioning of the recycle tank and the aeration tank can be such that there is gravity flow from the recycle tank into the aeration chamber, a pump connected to a timer being disposed in the aeration tank to pump, at desired intervals, water into the recycle tank.

In yet another aspect of the present invention, the recycle tank can be disposed internally of the pump tank.

In yet another aspect of the present invention, the recycle tank can have disposed therein a fixed film media for bacterial growth.

In yet a further aspect of the present invention, treated wastewater from a pump or holding tank can be introduced into a drip irrigation system, the drip irrigation system having an outlet, the outlet being connected to the pretreatment tank via a flow line, there being a valve in the flow line to control back pressure in the drip irrigation system at desired times, and permit flow from the drip irrigation system into the pretreatment vessel in desired amounts at times.

In yet another embodiment of the present invention, a pump, e.g., an airlift pump, submersible pump, etc., is disposed in the pretreatment vessel, the pump being activated for predetermined intervals to pump a portion of untreated wastewater in said pretreatment tank into the aeration chamber of an aeration tank.

In all of the embodiments described above, the goal is to achieve an environment which is anoxic such that the aerobic bacteria are starved which allows the denitrifying bacteria to convert the nitrogen nutrients, particularly nitrates, to nitrogen gas. Further, the clarifier chamber of the aeration vessel is not overloaded by any of the proposed embodiments.

### BRIEF DESCRIPTION OF THE DRAWINGS

FIG. 1 is a schematic view of a typical three-tank aerobic wastewater treatment system which shows one embodiment of the present invention;

FIG. 2 is a schematic view similar to FIG. 1 showing another embodiment of the present invention;

FIG. 3 is a schematic view of another embodiment of the present invention;

FIG. 4 is schematic view of another embodiment of the present invention;

FIG. 5 is a schematic view of another embodiment of the present invention;

FIG. 6 is a schematic view of another embodiment of the present invention; and

FIG. 7 is a schematic showing a variation of the embodiment of the present invention shown in FIG. 6.

### DESCRIPTION OF THE PREFERRED EMBODIMENTS

Turing first to FIG. 1, the aerobic wastewater treatment system is seen to comprise three main vessels, a pretreatment tank S, an aerobic digestion vessel A and a pump tank P. Three vessel wastewater treatment systems are well known and are depicted, for example, in U.S. Pat. Nos. 5,221,470 and 5,785,854, all of which are incorporated herein by reference. In operation, wastewater from a residence or the like passes through line 10 into pretreatment tank S. Most of the solids settle out in pretreatment tank S and largely solids-free, untreated wastewater passes via gravity through line 12 into aerobic digestion vessel (aeration vessel A). As is typical in systems of the type under consideration, aeration vessel A has a frustoconical partition 14 which serves to divide aeration vessel A into a clarifier chamber 16 and an aeration chamber 18. Disposed in aeration chamber 18 is a diffuser 20 which is connected by a conduit 22 to an air pump 24 or some other suitable source of an oxygen-containing gas. Thus, oxygen-containing gas is introduced into diffuser 20 via conduit 22 to provide sufficient oxygen for aerobic digestion of organic material in aeration chamber 18.

Clarified water enters the mouth 26 of partition 14 and flows via gravity through line 28 into a holding or pump tank P. In the typical aerobic system, pump tank P is equipped with a pump 30 which typically is connected to a timer 32 which can activate pump 30 and pump water out of pump tank P via line 34 for disposal via a variety of ways and at desired time. In the prior art system, in an attempt to denitrify the treated wastewater, a slip stream of the treated wastewater in pump tank P is returned to pretreatment vessel S. As noted above, typically pump 30 is set to run for extended periods of time, controlled by timer 32, such that a relatively large volume of recycle of treated water is returned to pretreatment vessel S. If this recycle stream is too great, it will cause an excessive amount of water to pass via line 12 into aerobic digestion vessel A and overload the aeration system such that sufficient digestion of the organics to produce clarified water cannot occur. Finally, a large volume of recycle flowing into pretreatment tank S from pump tank P reduces the residence time needed for the denitrifying bacteria to digest the nitrogen nutrients.

According to one aspect of the present invention, the prior art system as described above is modified to including a metering system which can selectively return a predetermined amount of treated wastewater from said pump tank T to said pretreatment tank S.

According to one aspect of the present invention employing a metering system, a trickle stream of recycle passes via a valve 36 and line 38 into pretreatment tank S, this trickle stream being controlled by a timer 32 connected to pump 30, a suitable solenoid (not shown) being used to control valve 36 so as to trickle the desired amount of recycle. Typically, this trickle stream would occur at a period of low usage of the wastewater treatment system, e.g., at night or it could occur on a continuous basis provided that return flow or recycle does not cause overload of the aeration vessel.

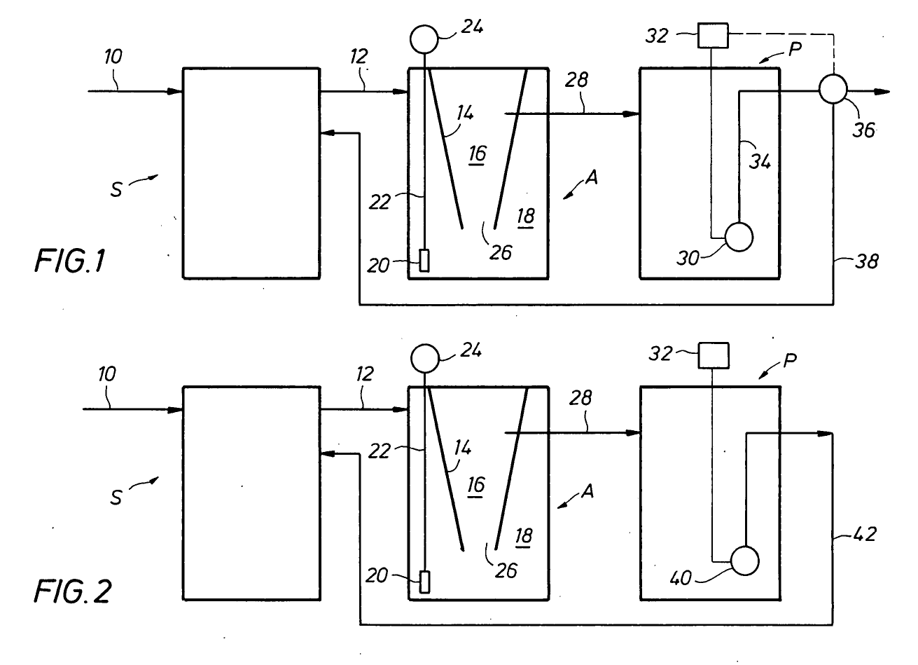

In yet another aspect of the present invention depicted in FIG. 2, a separate pump 40 can be installed in pump tank P, pump 40 being connected to a timer 44 and a line 42 which in turn feeds back into pretreatment tank S. In this scenario, timer 44 can be used to intermittently dose back some of the pretreated wastewater from pump tank P into pretreatment tank S. This dosing can occur over each 24 hour period. This dosing would prevent overload of the system. It will be recognized that rather than utilizing a separate pump 40, pump 30 via a suitable solenoid/valving system, can be used to accomplish the intermittent dosing as discussed above with respect to pump 40 and timer 44.

In the above embodiments wherein a metering system is employed, it can be seen that the metering system can comprise a valve, a timer, a pump, which can be the pump which discharges the water from the pump tank P or a separate pump if desired, the goal being to ensure that there is a controlled recycle of treated wastewater from the pump tank P to the pretreatment tank S, the amount of recycle not being dependent simply on when the pump 30 is discharging water from pump tank P with a concomitant recycle into pretreatment vessel S. In general, the amount of recycle per day either via trickle, intermediate dosing or any combination thereof, will be from 30% to 100% of the daily amount of untreated wastewater introduced in the pretreatment vessel S. As noted above, the metering system can operate at a variety of times, e.g., at night only, during the day only, over a 24 hour period in certain cases where a continuous trickle-back stream is employed, etc. Unlike prior art systems, wherein recycle from the pump tank P to the pretreatment vessel S is simply a function of when a pump such as pump 30 is discharging water from pump tank P, in the present invention, the return via trickle, dosing or any combination thereof, can be totally independent of when pump 30 is discharging treated wastewater from the pump tank P. Thus, while the metering system can be operable when the pump 30 is discharging wastewater from pump tank P and can employ pump 30, it is not controlled or tied to operation of pump 30 to discharge treated wastewater from pump tank P to a drain field, for drip irrigation, etc.

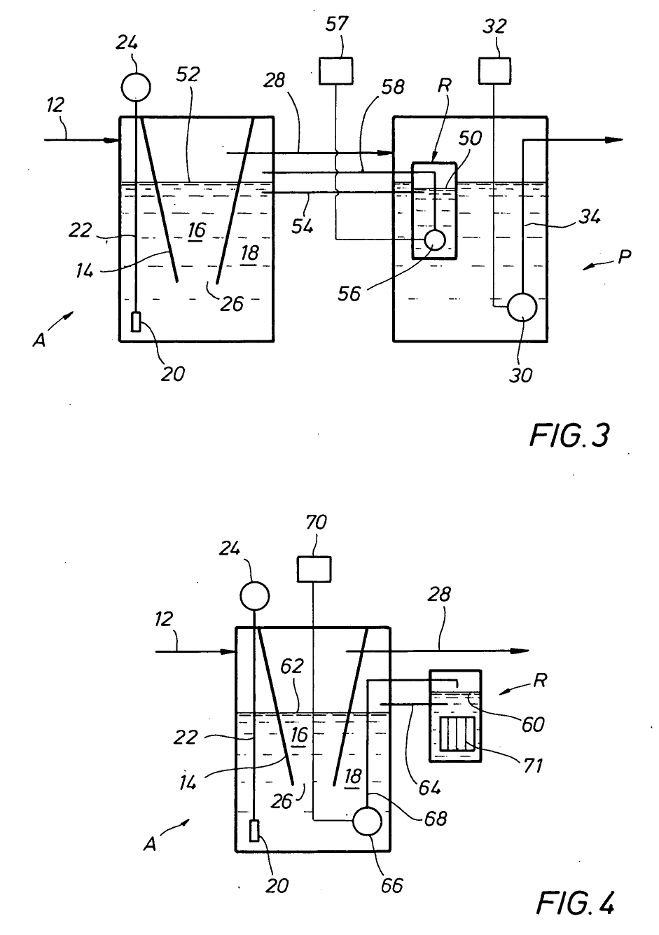

Turning now to FIG. 3, there is shown another embodiment of the present invention. For purposes of simplicity, pretreatment tank S has been omitted from the embodiment shown in FIG. 3. In the embodiment shown in FIG. 3, a separate recycle tank R is employed. Recycle tank R, as shown in FIG. 2, is positioned inside pump tank P but, as will be discussed hereafter, can be positioned outside of pump tank P if desired. In any event, recycle vessel R in the embodiment shown in FIG. 3 is positioned such that the water level 50 in recycle vessel R is below that of the water level 52 in aeration chamber 18. A flow line 54 provides open communication between aeration chamber 18 and recycle vessel R. Accordingly, water in aeration chamber 18 will flow via gravity through line 54 into recycle tank R. Also disposed in recycle tank R is a pump 56 which via line 58 can pump water from recycle tank R back into aeration chamber 18, pump 56 being connected to a timer 57.

Recycle tank R provides an environment for the denitrifying bacteria to digest nitrogen nutrients. In this regard, there is a long residence time and good mixing which results in the aerobic bacteria being starved thereby providing an anoxic environment which allows the denitrifying bacteria to digest the nitrogen nutrients, e.g., nitrates. It will be recognized that the water from aeration chamber 18 flowing into recycle tank R via line 54 contains sufficient organic material to provide a suitable source of energy for the denitrifying bacteria.

Referring now to FIG. 4 there is shown another embodiment of the present invention and again for simplicity both pretreatment S and pump tank P have been omitted. In the embodiment shown in FIG. 4, recycle vessel R is positioned such that the water level 60 therein is above the water level 62 in aeration vessel A. Accordingly, via a conduit 64, water can flow by gravity from recycle tank 60 into the aeration chamber 18 of aeration vessel A. A pump 66 is disposed in aeration chamber 18 and is connected via a line 68 into recycle tank R such that, in response to a signal from a timer 70, water can be pumped from aeration chamber 18 into recycle tank R via line 68. Both in the case of the embodiments shown in FIGS. 2 and 3, timers 57 and 70 are set so as to ensure adequate residence time in recycle tank R so as to enhance the action of the denitrifying bacteria.

As a modification, recycle vessel R can include a fixed film media 71 disposed therein which promotes bacterial growth. Media 71 can be used regardless of whether recycle tank R is separate from pump tank P or disposed in pump tank P. Additionally, media 71 can be used regardless of whether water is pumped via pump 56 back into aeration chamber 18 from recycle vessel R or pumped via pump 66 from aeration chamber 18 into recycle tank R.

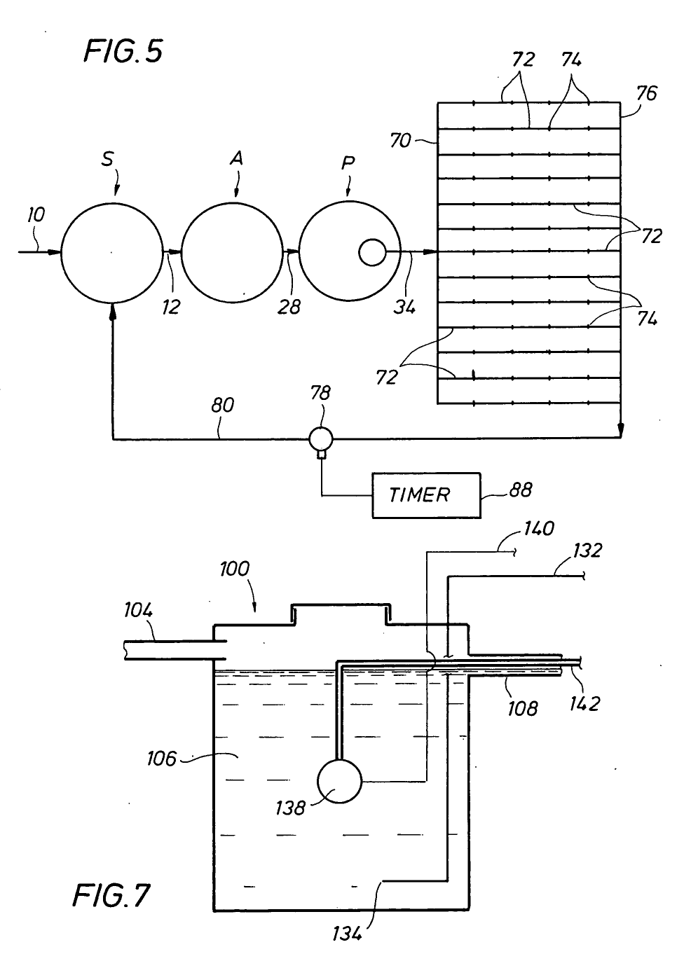

Turning now to FIG. 5 there is shown another embodiment of the present invention. In the embodiment shown in FIG. 5, treated wastewater from the pump tank P is introduced via line 34 from a pump 33 in pump tank P into the header 70 of a drip irrigation system comprised of a series of conduits 72 which are connected to header 70. Each of conduits 72 is provided with a plurality of drip outlets 74 such that the treated wastewater drip irrigates the ground in the area of the drip irrigation system. Such systems are well known to those skilled in the art. As noted, lines 72 are connected on one end to a header 70. Lines 72 are also connected on their opposite ends to a pressure line 76. Typically, pressure line 76 is connected to a valve, e.g., a ball valve 78, which maintains a back pressure of approximately 20 psi in the lines 72. This ensures that when pump 33 in the pump tank P introduces water via line 34 into the drip irrigation system, the drip outlets 74 are cleared so that the drip irrigation system will continue to operate efficiently. According to the embodiment shown in FIG. 5, valve 78 is positioned in a line 80 which is connected to pretreatment tank T. Thus, water passing through the valve 78 will pass via line 80 into pretreatment tank T. Once again, the system shown in FIG. 5 provides conditions for the denitrifying bacteria to digest nitrogen nutrients. While valve 78 is shown as being in line 80, it will be apparent that valve 78 could be located at the outlet of the drip irrigation system.

It will also be recognized that valve 78, regardless of its position in the system, will be connected to a timer 88 which could be the same timer that controls pump 33 in pump tank P and via a suitable solenoid system can be used to maintain valve 78 closed when the pump in pump tank 34 comes on for a sufficient period of time to obtain the desired back pressure in the drip irrigation system to make sure that drip outlets 74 not plug. However, after some period of time, timer 88 would then open valve 78 to allow flow through line 80. In any event, it will be seen that in the embodiment shown in FIG. 5, valve 78, regardless of its position, serves both as a back pressure device to clean drip outlets 76 while also, permitting flow through line 80 and into pretreatment tank S.

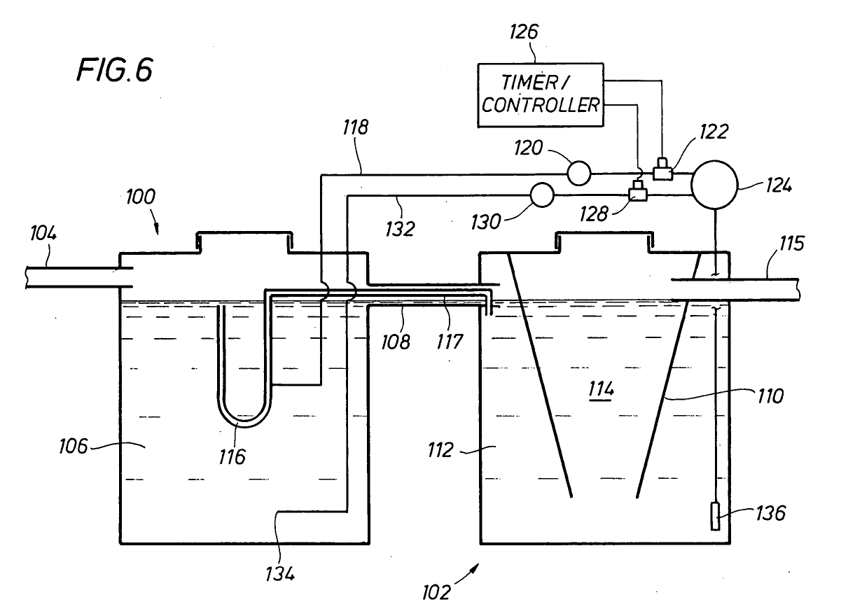

Referring to FIG. 6, there is shown a pretreatment tank, indicated generally as 100 and an aeration vessel, indicated as generally 102. For simplicity, the holding or pump tank has been omitted. In this regard it is understood that in certain cases a holding or pump tank is not employed and that water from aeration vessel 102 can simply be discharged by gravity flow. An inlet 104 connects pretreatment vessel 100 to a source of raw sewerage, shown as 106 in FIG. 6. Pretreatment vessel 100 is connected via a conduit 108 to aeration vessel 102. Aeration vessel 102, as is typical contains a frustoconical partition 110 which divides the interior of aeration vessel 102 into an aeration chamber 112 and a clarifier chamber 114. As can also be seen in FIG. 6, and as is typical in aeration vessels, air pump 124 is connected to a diffuser 136 which introduces oxygen into aeration chamber 112 for the purpose of aerobic digestion. Clarified water in chamber 114 flows via line 115 to a pump tank, a drain field, etc. As can be seen, conduit 108 provides open communication between pretreatment vessel 100 and aeration chamber 112 such that untreated wastewater in pretreatment vessel 100 can flow via gravity into aeration chamber 112 and water in chamber 112 can flow via gravity back into pretreatment vessel 100.

Disposed in aeration vessel 100 is an airlift pump depicted as 116, airlift pump being connected via a line 118 to a flow restrictor/valve 120, a solenoid 122, and ultimately to an air pump or compressor 124. Solenoid 122 is in turn connected to a timer controller 126. Air pump 124 is also connected via a second solenoid 128 and a flow restrictor/valve 130 to a line 132 which terminates generally in the lower portion of pretreatment vessel 100 and has an open end 134. The purpose of air line 132 is to introduce air, at desired times, which can be determined by timer controller 126 solenoid 128 and flow restrictor/valve 130, into pretreatment vessel 100 to provide some gentle mixing to prevent the solids from settling to the bottom of aeration vessel 100 and to essentially maintain the solids in suspension such that a generally homogeneous anaerobic condition exists to the untreated wastewater 106 in pretreatment tank 100. It is to be understood that the amount of air entering pretreatment vessel 100 from air line 132 through open end 134 is controlled so as to prevent an aerobic atmosphere from being created in the untreated wastewater 106. Essentially, as opposed to using a diffuser, air line 132 emits or “burps” big bubbles which provide adequate mixing but avoids creating an aerobic atmosphere condition in untreated wastewater 106. As is well know to those skilled in the art, typically the untreated wastewater 106 is for the most part anaerobic such that denitrifying bacteria are able to breakdown nitrogen compounds. Thus, the air line 132 cannot be considered a source of aeration sufficient to drive the untreated wastewater 106 into an aerobic condition. It is to be observed that when air is being introduced to airlift pump 116, it removes some of the anaerobic, untreated wastewater 106 from pretreatment vessel 100 and returns it into aeration chamber 112. Typically, airlift pump 116 would be operable when there is no untreated wastewater 106 coming into the system, i.e., via line 104. Accordingly, during those periods and using airlift pump 116, a constant controllable flow of untreated wastewater 106 can be introduced into aeration chamber 112 via line 117. At the same time, during this period, this “mixed liquor” in aeration chamber 112 will flow by gravity back into pretreatment tank 100. This return liquid is nitrified by the action of air in aeration chamber 112, e.g., it contains nitrates. By returning it to pretreatment tank 100 the denitrifying bacteria can act on the nitrified water returned from aeration chamber 112 since it is in an anoxic environment in pretreatment vessel 100 (DO between about 0 and 1 ppm). The airlift pump 116 in conjunction with line 108, act as a control system in the sense that the greater the air flow to airlift pump 116, the more the flow of untreated wastewater 106 into aeration chamber 112. However, this results in more of the aerated water or mixed liquid in aeration chamber 112 passing back via line 108 into pretreatment vessel 100.

Turning to FIG. 7 there is shown a modification of the system shown in FIG. 6. For simplicity purposes, only pretreatment vessel 100 has been shown. The difference between the embodiment shown in FIG. 6 and that shown in FIG. 7 is that in lieu of airlift pump 116, there is an electric, submersible pump 138 which is connected to a source of power and a controller (not shown) via a line 140. When activated, pump 138, like airlift pump 116, pumps a desired amount of water via line 142 from pretreatment vessel 100 into aeration chamber 112.

In both of the embodiments shown in FIGS. 6 and 7, the combination of the pump, e.g., airlift pump 116 or submersible pump 138 in combination with the connecting conduit 108 and air line 134 is to ensure that the oxygen content in pretreatment tank 100 stays below about 1 ppm but above 0 ppm. This is accomplished by the combination of introducing some of the untreated wastewater 106 into aeration chamber 112 while ensuring via lines 132 and open end 134 that a non-aerating amount of oxygen is introduced into pretreatment tank so that the DO does not exceed 1 ppm in pretreatment tank 100.

It will be appreciated that in the case of the various pumps used, e.g., pump 40, pump 66 or pump 56, these could all be airlift pumps driven by air compressor 24. Alternatively, the pumps could be electric.

Another modification of some of the embodiments of the present invention involves the use of a dissolved oxygen (DO) probe disposed in the pretreatment tank to determine the oxygen content of the water in the pretreatment tank. The DO meter could then be connected to the pump in pump tank P such that when the DO meter indicated no dissolved oxygen or at least less than 1 ppm in the water in pretreatment tank S, some water would be directed from the pump tank P back to the pretreatment tank S. In this regard to maintain an anoxic state, the DO should be between 0 and 1 ppm.

A common feature of all of the embodiments of the present invention is that water which is highly nitrified, e.g., contains nitrates, is returned to an anoxic environment to be denitrified, all of the embodiments ensuring that the DO in the vessel or tank containing the denitrifying bacteria is controlled in a narrow range so as to maintain that environment anoxic. It will be appreciated that in all of the embodiments discussed above via the use of suitable timer/controllers, solenoids, valves, etc., careful control of the DO in the “anoxic” medium, can be maintained and denitrification of nitrified water carried out. Additionally, unlike the prior art systems, the embodiments of the present invention accomplish denitrification without fear that the system may be overloaded, e.g., an overload of the clarifier chamber. Thus, all of the embodiments provide methods, as well as apparatus wherein denitrification processes can be conducted in a typical aerobic wastewater treatment plant without an upset via excessive volume to the clarifier chamber.

The foregoing description and examples illustrate selected embodiments of the present invention. In light thereof, variations and modifications will be suggested to one skilled in the art, all of which are in the spirit and purview of this invention.

What is claimed is:

1. In an aerobic wastewater treatment plant comprising a pretreatment vessel, an aeration vessel and a holding vessel for holding treated wastewater, the improvement comprising:
a recycle system for returning a portion of said treated wastewater in said holding vessel to said pretreatment vessel, said recycle system including a metering system to return a predetermined amount of said treated wastewater from said holding vessel to said pretreatment vessel at selected times.

2. In an aerobic wastewater treatment plant comprising a pretreatment vessel and an aeration vessel forming an aeration chamber and a clarifier chamber for aerating and clarifying wastewater, the improvement comprising a recycle tank, a conduit providing open communication between said recycle tank and said aeration chamber, and a pump disposed in one of said recycle tank or said aeration chamber, wherein when said pump is disposed in said aeration chamber wastewater can be pumped from said aeration chamber to said recycle tank, said conduit being positioned relative to said recycle tank and said aeration chamber to permit gravity flow of wastewater from said recycle tank to said aeration chamber and wherein when said pump is disposed in said recycle tank, wastewater can be pumped from said recycle tank to said aeration chamber, said conduit being positioned relative to said recycle tank and said aeration chamber to permit gravity flow of wastewater from said aeration chamber to said recycle tank.

3. In an aerobic wastewater treatment plant comprising a pretreatment vessel, an aeration vessel, a holding vessel for holding treated wastewater, a drip irrigation system connected to said holding vessel, a pump for introducing treated wastewater from said holding vessel into said drip irrigation system, said drip irrigation system having an outlet, the improvement comprising a flow line connecting said outlet to said pretreatment vessel, a valve disposed in said flow line and a timing system connected to said valve to selectively open and close said valve for selected periods of time.

4. In an aerobic wastewater treatment plant comprising a pretreatment vessel, an aeration vessel forming an aeration chamber in the clarifier chamber for aerating and clarifying wastewater, a conduit providing open communication between said pretreatment vessel and said aerobic chamber, a pump disposed in said pretreatment chamber and having a pump discharged into said aerobic chamber, whereby a portion of untreated water in said pretreatment tank can be discharged into said aeration chamber, said conduit permitting gravity flow from said pretreatment vessel to said aerobic chamber and from said aerobic chamber to said pretreatment vessel to said holding vessel.
